(19) United States
(12) Patent Application Publication
(10) Pub. No.: US 2018/0213339 A1
(43) Pub. Date: Jul. 26, 2018

(54) ADAPTING HEARING AIDS TO DIFFERENT ENVIRONMENTS

(71) Applicant: Intel Corporation, Santa Clara, CA (US)

(72) Inventors: Rahul Chandrakant Shah, San Francisco, CA (US); Rita H. Wouhaybi, Portland, OR (US); Jonathan J. Huang, Pleasanton, CA (US); Lama Nachman, San Francisco, CA (US)

(21) Appl. No.: 15/413,012

(22) Filed: Jan. 23, 2017

(51) Int. Cl. H04R 25/00

(52) U.S. Cl. CPC H04R 25/558; H04R 25/30; H04R 2225/55; H04R 2225/39; H04R 2225/41

(57) ABSTRACT

In some embodiments, the disclosed subject matter involves a system and method relating to improving the user experience of hearing, using an adaptable or adjustable hearing aid that takes environmental conditions into account when changing modes. A local server or gateway or cloud service iteratively analyzes the audio environment and feedback from the user to automatically change settings and mode of the user's hearing aid to improve hearing. Information from other users in similar audio environments may be used to assist in mode changes. Information about the audio environment, hearing aid settings/mode and user feedback may be correlated for future use by the user, or crowdsourced for other users, the hearing aid manufacturer or audiologist. Other embodiments are described and claimed.

### TECHNICAL FIELD

An embodiment of the present subject matter relates generally to hearing, and more specifically, to improving the use of hearing aids using environmental information and user feedback.

### BACKGROUND

Over the last few years, many applications have been developed to assist and augment users' abilities. However, hearing continues to be stigmatized with very little technological advancement, Despite advancement of hearing aids, the aids on the market remain fairly static. A patient often gets fitted for a hearing aid with a procedure similar to eyeglass fitting. However, hearing is often more intricate than eyesight. Hearing tests are conducted in quiet rooms that do not exist in real life. As a result, the measurements are not reproducible. When the patient then gets a hearing aid, the hearing aid is often trying to compensate in a non-linear fashion using a baseline that cannot be reproduced. Modern hearing aids often contain multiple modes which can compensate in different ways based on the frequencies, but can also switch to very different hearing profiles. However, hearing is more complex than a binary switch between a handful of modes. Also, existing hearing aids may only have a few different modes for different acoustic environments. When a mode is found that works for a user, then there is no way to use that information to help others. In current systems, there is also no way to provide detailed feedback to the audiologist that would help them in adjusting the hearing aid for the person.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 is a block diagram illustrating users in an environment, where some users utilize hearing aids, according to an embodiment;

FIG. 2 is a flow diagram illustrating a method for adapting hearing aids, according to an embodiment;

FIG. 3 is a block diagram illustrating a system for adapting hearing ads, according to an embodiment; and

FIG. 4 is a block diagram illustrating an example of a machine upon which one or more embodiments may be implemented.

### DETAILED DESCRIPTION

In the following description, for purposes of explanation, various details are set forth in order to provide a thorough understanding of some example embodiments. It will be apparent, however, to one skilled in the art that the present subject matter may be practiced without these specific details, or with slight alterations.

An embodiment of the present subject matter is a system and method relating to improving the user experience of hearing, using an adaptable hearing aid that takes environmental conditions into account when changing modes. In at least one embodiment, the user experience is enhanced by using a hearing aid that is better able to adapt to different acoustic environments and provides better feedback to audiologists for them to understand the conditions under which the hearing aid does not perform as well. The feedback may be provided both by the user as well as using crowdsourcing so that hearing aid manufacturers/audiologists have more data to correct the problems in the system.

In existing systems, a hearing aid is adjusted in very quiet or a few limited acoustic environments, but it has to function well in a much wider variety of environments and for people who may have wide variations in hearing loss. Systems as described herein automatically identify scenarios where the person is having a hard time hearing, as well as identify when the user is pleased with their level of hearing. The system described herein provides a mechanism for the user to provide feedback that the user is having difficulty, so the system may identify scenarios and collect live data where the user is not able to hear well.

Once the appropriate data is collected, embodiments may adjust the hearing aid audio so that the user can perceive audio in an improved fashion. Being able to make the adjustments in real-time allowed the hearing aid to adapt to various condition, such as the room acoustics, audio environment, other time-varying physiological problems such as tiredness, illness, etc. The described system may also provide feedback for an audiologist, and crowdsource some of this information, so that audiologists may better adapt the system to other users/patients.

For most users, their hearing profile depends on many factors, such as how rested they are, the signature of noise around them, the familiarity with the voices (speech or others) that they want to hear, their emotional state, their physical state including cold or flu episodes, etc. In addition, feedback to determine whether something needs to be further amplified or filtered is often a difficult process. In existing systems, when a user notices an undesirable outcome while using their hearing aid, the user needs to describe the performance using words, and without accurately being able to capture conditions in the environment.

Reference in the specification to “one embodiment” or “an embodiment” means that a particular feature, structure or characteristic described in connection with the embodiment is included in at least one embodiment of the present subject matter. Thus, the appearances of the phrase “in one embodiment” or “in an embodiment” appearing in various places throughout the specification are not necessarily all referring to the same embodiment, or to different or mutually exclusive embodiments. Features of various embodiments may be combined in other embodiments.

For purposes of explanation, specific configurations and details are set forth in order to provide a thorough understanding of the present subject matter. However, it will be apparent to one of ordinary skill in the art that embodiments of the subject matter described may be practiced without the specific details presented herein, or in various combinations, as described herein. Furthermore, well-known features may be omitted or simplified in order not to obscure the described embodiments. Various examples may be given throughout this description. These are merely descriptions of specific embodiments. The scope or meaning of the claims is not limited to the examples given.

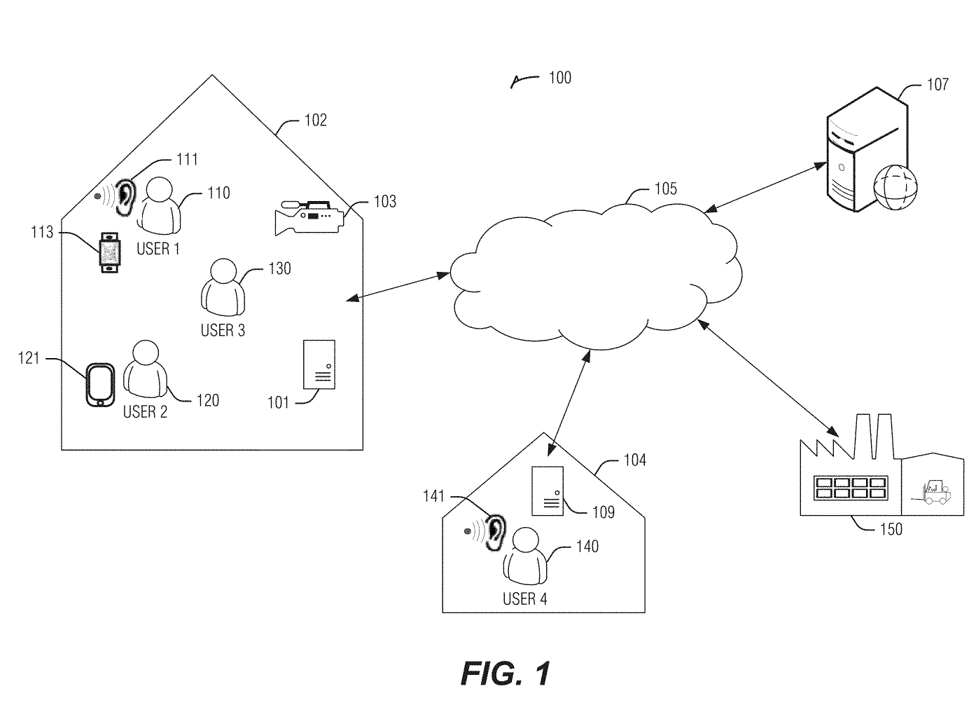

FIG. 1 is a block diagram illustrating users in an environment 100, where some users utilize hearing aids, according to an embodiment, in an example, building or home 102 shows three users. User 1 (110), User 2 (120), and User 3 (130), User 110 is shown with a representation of a hearing aid 111 and a smart watch 113. User two 120 is shown with a smart phone 121. Camera 103 may be used to observe gestures and movements as described below. Gateway 101 communicates with a network in the cloud 105. The gateway 101 may communicate with one or more cloud services 107. It will be understood that a cloud service may provide applications, resources and/or data via one or more servers on the network, e.g., the cloud. In an example, user 130 is speaking to user 110. User 110 may have difficulty hearing speech from user 130. When user 110 is aware of difficulty hearing, User 110 might shake, twist or move the smart watch 113 in a way that is detectable to an accelerometer or other movement sensor on the watch. Tactile input may also be used with the smartwatch 113, such entering commands by Swype or text on the screen, or by pressing a button or turning a dial on the smartwatch 113 to indicate to the system that the audio is hard to hear. In an example, user 110 may perform a visual gesture such that camera 103 may capture the movements that indicates the audio is hard to be heard. The camera 103 may communicate with gateway 101 to identify the gesture as well as forward it on.

Detecting hearing difficulty may be performed in several ways. In one example, a listening device on a user's smart watch or smart phone or microphone in the environment may be used to detect speech from user 110 that might indicate difficulty hearing. For instance if user 110 continues to say “what” or “huh” or “what did you say,” such phrases would be a good indicator that there is some difficulty hearing. In another example the hearing aid 111 may be equipped with a gyroscope or accelerometer to identify when user 110 tilts her had indicating that she is trying to hear better. Hearing aid 111 also may detect motion from the hearing aid, such as caused by one rubbing one's ear. A button may be provided on the user's smart phone or another wearable, for instance, a ring, a watch, or pendant, etc. Similarly, camera 103 may detect a head tilt or other visual, physical gesture to indicate difficulty hearing. In an embodiment, the frequency or severity of gestures or signals by the user may result in a qualitative measure of the difficulty of hearing. For instance, the more often a user indicates hearing difficulty the lower the qualitative measure on a scale of 1 to 10. The scale may be set differently for different environments, users, or implementations. In an example, the user may provide explicit qualitative feedback on the hearing experience, such as scale of “I can't hear a thing” to “I can hear everything clearly.”

Once an indication of hearing difficulty has been made, an attempt at adjusting hearing aid 111 may be performed. In an embodiment, the gesture is detected on a user device such as a watch 113 or smartphone 121. The user device may be paired with the hearing aid 111 and used to make adjustments directly. In another embodiment, the camera 103 captures images and sends them to the local gateway 101, which analyzes the images and detects the difficulty. In one embodiment, the gateway 101 may transmit a signal, for instance, via an IEEE 802.11 (Wi-Fi®) networking standard, directly to the user's hearing aid 111. In another embodiment, the local gateway 101 may transmit a signal to the user's smartphone 121, watch 113, or other wearable, which then relays the adjustment to the hearing aid 111. It may be advantageous for a gateway 101 to communicate with a wearable or smart phone on the person rather than requiring the hearing aid to have a Wi-Fi® transmitter. In this way, the hearing aid only needs to have a near field communication device or Bluetooth or other near-proximity based wireless transmitter meant for short distances. This reduces the amount of power required on the hearing aid.

In an embodiment, user 4 (140) is in environment or building 104. An example environment 104 may be a noisy location such as a restaurant. User 140 has hearing aid 141 which may communicate with a local gateway 109. The environment for hearing in building 104 may be very different than in environment or building 102. Thus, user 140 may require different settings on hearing aid 141 then user 110 with hearing aid 111 even if there hearing profiles and abilities are similar.

In an embodiment, user 110 may not realize that user 130 is speaking to her. In an example, user 110 may have her back to user 130 and not hear any speaking. However, if user 110 has a smartwatch 113 or other wearable, or a smartphone 121, or there are microphones in the room connected to the local gateway 101, the speech of user 130 may be captured and the fact that user 110 did not respond may trigger the system to make an indication that the user 110 did not hear the speech. In an example, the hearing aid 111 may be automatically adjusted until user 110 reacts to the speech. If user 110 has the smartwatch 113 paired with the hearing aid 111 and with the gateway system 101, a tactile response may be triggered to alert user 110 that something was said that she did not hear. In an embodiment, any mobile device in the environment, for instance smartwatch 113 and smart phone 121, regardless of who is carrying them, may be paired with the gateway 101 to stream the background noise in the room. This may provide a context for the decibel level and the noise level in the environment. The audio streaming may also be able to identify when a person is speaking so that the system can determine whether or not a user with the hearing aid 111 reacts and has heard the speech. For instance smart phone 121 being held by user 120 may stream the audio to the gateway 101 while user 130 is actually speaking, and user 110 has the hearing aid 111.

Camera 103 may be able to identify and capture gestures, as well as identifying lip movement to indicate speech. For instance in an example, camera 103 may capture user 130 lips moving so that the system infers that user 130 is speaking. If user 110 does not respond, then the system at the gateway 101 may infer that user 110 did not hear user 130 and send appropriate signals to update and adapt the settings on hearing aid 111. User 130 may be speaking, but may be speaking on a Bluetooth device to their own smart phone. User 130 may not actually be speaking to user 110. Other visual clues captured by camera 103 may be used to help identify whether user 130 is actually speaking to user 110. Language context may also be used. For instance, in a home system the local gateway may be preset to identify the spoken name of user 110. If gateway 101 processes the audio and detects that the name of user 110 was spoken, an indication that someone is speaking to user 110 may be noted. This may trigger identification that user 130 is speaking to user 110 in the system. A wearable, smart phone, smartwatch or other device paired with hearing aid 111 may pair with the local gateway 101 upon entry into the environment and the noting audio matching the user's name may be part of that set up. Thus, even in a public environment the user's spoken name may trigger identification that someone is speaking to that user.

In an embodiment, environment 104 may have a local gateway 109. Gateway 109 may include the hearing aid system and feedback application that is also on the cloud. However some users may not want their data to be sent out to the cloud for privacy or other reasons. So, in this example user 4 (140) has hearing aid 141. In this example adjustments and feedback for the user and hearing aid 141 are only to local gateway 109. User 140 may choose to allow some information to be sent to the cloud 105 for transmission back to the manufacturer 150 or to an audiologist with access to cloud services 107.

In an embodiment, audio captured by any one of the user's mobile devices or microphone in the environment, or simply the microphone in the hearing aid that is paired with another device, may send or stream the audio information to the cloud service 107 via the cloud 105. The cloud service 107 may use natural language processing or automated speech recognition to identify key words or phrases that indicate the user is not able to hear a conversation, or key words or phrases to trigger an update or reset of the mode of the hearing aid 111, based on the environment. Cloud service 107 may perform audio signal classification to characterize or classify the environment. Audio signal classification (ASC) may include extracting relevant features from this sound and using those features to identify into which set of classes the sound is most likely to fit. Feature extraction and grouping algorithms may be used and may vary based on the environment, or application associated with the user. Perceptual information, such as the words or phrases as described above, or gestures, may be combined with the audio classification to provide more detail about the environment and listening experience. Artificial neural nets such as CNN (convolutional neural network) and DNN (deep neural network) may be used, including using hidden Markov models (HMM) and other techniques to classify the audio.

Other information may be received in audio signals to help indicate the type of environment in terms of its audio quality. For instance the decibel level, the number of identifiable voices or conversations, identifiable road traffic, or white noise, can help identify, or classify, the environment. Various algorithms may be used to analyze the audio characteristics. Once the environment has been characterized, or classified, the cloud service may automatically send a signal back to the user's hearing aid 111 to update its mode. It will be understood that even though it is described above to perform the classification on the cloud service 107, that the classification may be performed on a local server or gateway 101, 109 instead. It will be understood that classification and analysis processes may be performed at the cloud service 107 or at the gateway 101, 109, and that the processes may be distributed among the servers, as desired.

As the user navigates his or her way through the world, the user's environment may change drastically from one moment to another from being in a quiet place to being in a noisy place. If this type of change can be identified in the cloud service 107, or at the local gateway 101, 109, then the hearing aid mode may be updated automatically. Thus, with automatic updates, the user will not have to constantly monitor or manually change the settings. If the automatic analysis is not found optimal, the user may trigger a new classification analysis of environment via a number of triggers. For instance, the user may make a pre-defined gesture that is captured by a camera 103 or motion sensor (not shown), or shake a wearable device 113, or press a button, or speak a specific phrase, etc.

The cloud service 107 may keep track of various audio environments (e.g., classifications) and how users relate to them in terms of requesting a change of mode in the hearing aid, or an automatic change in the mode when the initial change does not result in a positive effect. For instance, when the cloud service 107 changes an audio setting on a hearing aid, if the user still indicates that they cannot hear, then that historical data may be saved to help provide better adjustments in the future. Similar data from multiple users may be correlated for a crowdsourcing effect. These types of parameters and feedback may be correlated in the cloud service 107 and then sent to either the hearing aid manufacturer 150 or to an audiologist who has access to this data in the cloud.

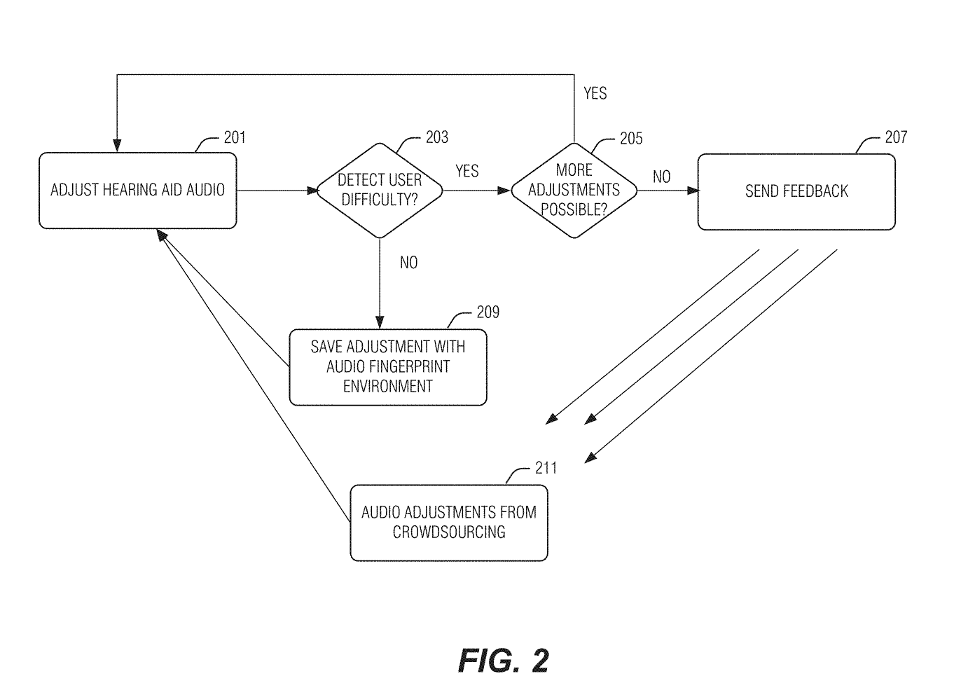

FIG. 2 is a flow diagram illustrating a method for adapting hearing aids, according to an embodiment. The user with a hearing aid may adjust their hearing aid audio settings in block 201. This may be as simple as inserting the hearing aid into the ear and turning it on as an initial step. The system determines whether the user is having difficulty hearing in block 203. This may be done as discussed above, with a proactive trigger, or single button press, or a pre-defined gesture, a head tilt, or a natural language processor (NLP) or automatic speech recognition algorithm (ASR) identifying that the user is repeating a key word or phrase to indicate that the user cannot hear. In an embodiment, a camera assembly communicatively coupled to an analysis component may identify a head nod/tilt or other gesture, or note that a different user is speaking but the user with the hearing aid is not responding. The camera assembly may be mounted in the environment, or be coupled with a mobile device in the environment, such as a smartphone, wearable or other device. If the mobile device is registered with the analysis system to send images to the local gateway or cloud, then the mobile device need not be located on the same user as is using the hearing aid. If the system detects that the user is having difficulty hearing, the analysis system then looks at the current settings of the hearing aid and determines whether more adjustments are possible, in block 205.

If more adjustments are possible, then the hearing aid audio may be adjusted, in block 201. The adjustments may be automatically performed, responsive to a request from a local gateway, a wearable or smart phone paired with the hearing aid, or directly from the cloud service via a wireless communication path in the environment.

Different audio adjustments or filters may be automatically attempted in block 201. The hearing aid may determine if any of the filters are helping the user hear better, based on feedback, or lack of a gesture to indicate that hearing is still impaired. One purpose of the hearing aid is to improve the intelligibility of human speech using various speech enhancement algorithms. Having knowledge of the speech source (e.g., child vs. adult male voice), and of the background noise (environmental classification) may help select the appropriate algorithm, or parameters of the algorithm, for enhancing the intelligibility of speech. Another benefit of using environmental context is that the hearing aid may choose the minimal signal processing required by environment, to better conserve power in less challenging situations. In another embodiment, if the audio adjustments are not providing acceptable results, then the system may automatically provide a visual translation of the speech. For instance, the analysis system may perform a speech to text conversion and display the text on a user device like a smartphone or tablet display, a wearable display, a heads up display, a wall or monitor in the environment, etc. Using context acquired in block 201 may help automatic speech recognition (ASR). For example, if speaker recognition identifies a frequently encountered person (such as a spouse), a customized acoustic model for that person may be loaded to enable the ASR to be more robust.

Another alternative is to convert the text back to speech and play it back into the hearing aid itself using a text-to-speech (TTS) engine. In this example, the audio would be clear, and the noisy environment or the quality of the audio of the person talking would not be an issue. The analysis system may remove noise and extraneous audio signals to clean up the audio before sending it back to the user. An analysis component on the local gateway, or cloud service, or paired device may identify the audio quality of the environment (e.g., classification) and choose a mode automatically for adjustment. The mode selection may be made based on previous user feedback. The speech may be played back almost simultaneously, with slight delay, or be delayed for a predetermined period, so as not to overlap too much with the person speaking.

Blocks 201, 203 and 205 may be continuously iterated as the user goes about their day and enters and exits various environments. If, in block 205, it is determined that no more adjustments are possible, feedback may be sent at block 207 to either the local gateway or the cloud service to indicate that the hearing aid has reached the limit of adjustments and may or may not provide acceptable hearing assistance to the user. The user may choose to manually send feedback, as well, saying, for instance, “I'm at the office and I keep adjusting it, I can't hear anything,” or to provide valuable information for a manufacturer or audiologist. Other feedback information may be sent that identify more personal conditions of the user. For example, a gesture or visual feature recognition system using cameras proximate to the user may identify that the user seems tired (e.g., head nodding, or eyes drooping), emotionally distraught (e.g., dabbing tears from their eyes, sweating unnaturally in a climate controlled environment), or that the user is likely battling an illness (e.g., frequently coughing, sneezing, clearing the throat, etc.). These perceived physical or emotional characteristics may be provided as feedback along with other environmental conditions, hearing aid mode, quality of hearing level, etc., to help provide additional context for the hearing experience.

The feedback sent at block 207 may sent automatically. In an example, the hearing aid may be set to send periodic feedback, or feedback triggered by an adjustment or an attempted adjustment of the hearing aid.

In block 203, if it is determined that the user is not having difficulty hearing, then the environmental information and audio characteristics of the environment, as well as the settings of the hearing aid, and possibly emotional and physical conditions, may be saved as an audio fingerprint of the environment and forwarded to the local gateway, or the cloud service, in block 209.

In an embodiment, feedback sent to the cloud service from various users may be correlated to provide a better prediction of which audio settings on the hearing aid will provide better hearing assistance for specific environments. Thus, the adjustments may be crowdsourced, and characteristics saved in the cloud service. This information may trigger an audio adjustment for the hearing aid based on environmental data sent from the environment to the cloud service or local gateway, in block 211.

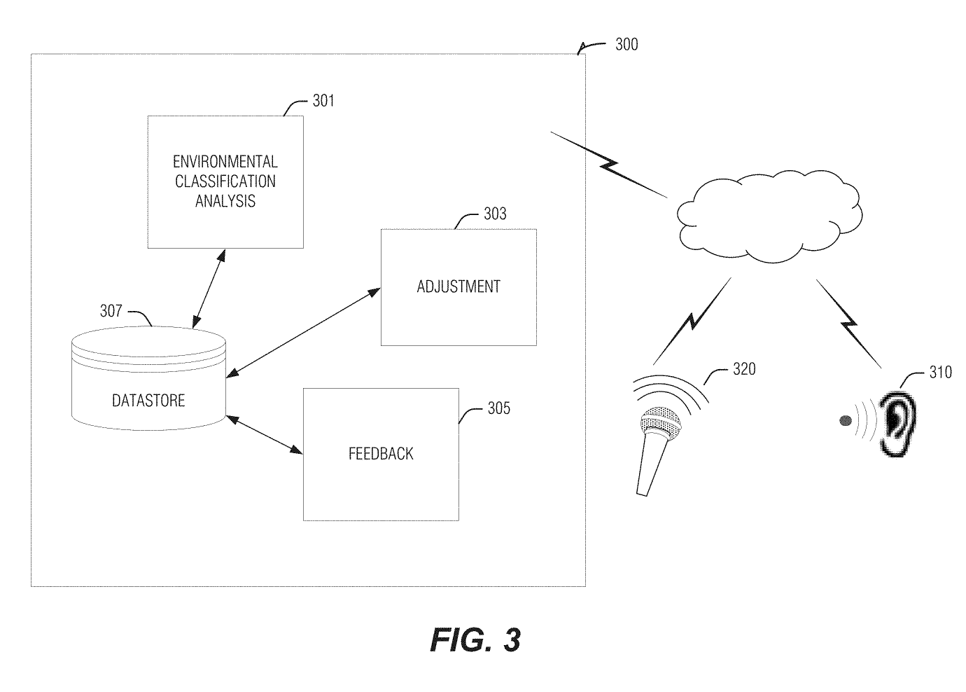

FIG. 3 is a block diagram illustrating a system for adapting hearing aids, according to an embodiment. In an embodiment, an analysis component 301 receives audio from an environment. The sound quality in the environment is classified using various ASC techniques. Information about known or similar classification parameters may be stored in data store 307 and used to assist in the classification. Current classifications and parameters for frequently visited environments may be stored, as well. The hearing aid, or other device carried or worn by the user may provide GPS or other location coordinates to the analysis component to identify a specific place or environment. The audio is captured by an audio capture device 320 such as a microphone in the environment that may be separate from the hearing aid (e.g., mounted on the wall, microphone in a smartphone, etc.). In another embodiment, the audio captured by the hearing aid 310 is sent to the analysis component. The audio signals may be sent directly if the adaption system 300 is nearby, or passed through a gateway (not shown) or via a smartphone or other paired device. By using a relay device such as a wearable, smartphone or local gateway for transmission to the adaption system 300, power and transmission requirements on the hearing aid may be minimized.

In an embodiment, the analysis component 301 receives images or video corresponding to the environment. In an example, the images or video is analyzed by a gesture recognition component (not shown) to identify gestures from the user of the hearing aid that indicate that the user is having difficulty hearing. In an example, the images/video is analyzed by the gesture recognition component to identify when a second user is speaking and the user of the hearing aid appears not to hear the speaker. In an embodiment, the gesture recognition component may be the same component as the environmental analysis component, or a separate component within the system.

Feedback component 305 may receive information from the user regarding the quality of the hearing experience. When a user is having difficulty hearing, pro-active feedback or signaling may be sent to the system 300, as described above. In another embodiment, the local gateway in the environment may send perceived feedback, as discussed above, for instance, when a camera assembly identifies that the user is ignoring speech by a second user. Information about the current specifications, settings and operational mode of the hearing aid 310 is stored in data store 307, along with the feedback information.

The adjustment component 303 uses the environment classification, feedback and hearing aid specific information, retrieved from the data store 307, to determine whether adjustment of the hearing aid is possible, and can be beneficial. For instance, if the environment is classified as a busy city street, and the hearing aid is equipped with a filter for this type of noise, the adjustment component may send instructions to the hearing aid 310 to turn on this filter, or to change modes to a mode that uses this filter. In another example, if the classification indicates that a child with a high pitch voice is speaking, and the user has a high frequency hearing loss, the adjustment component may send instructions to the hearing aid to transform the speech such that the characteristics (such as pitch) may be better matched with the user's listening sensitivity. In other words, the mode may identify a configuration of adjustment parameters and/or filters associated with the capabilities of the hearing aid that may be adjusted to provide a better quality hearing experience.

If the system 300 continues to receive feedback that the user is having difficulty hearing, the analysis and adjustment processes may continue to iterate until all possible combinations of modes and settings have been exhausted. Once the user indicates that the quality of the audio is acceptable, and this may be by failing to provide additional feedback, the classification identification may be correlated with the current hearing aid settings and stored in the data store 307, for future predictive use.

In an embodiment, data from several users may be correlated to identify common settings for similar classifications that are found acceptable. If confidence in the correlation is high, these settings may be the first adjustments attempted by the adjustment component.

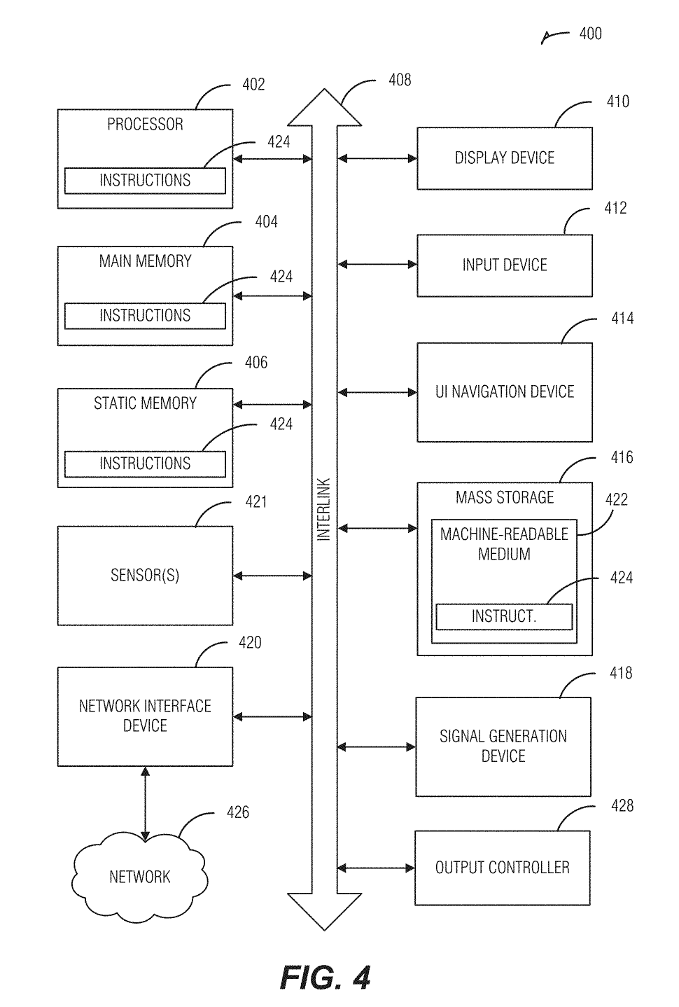

FIG. 4 illustrates a block diagram of an example machine 400 upon which any one or more of the techniques (e.g., methodologies) discussed herein may perform. In alternative embodiments, the machine 400 may operate as a standalone device or may be connected (e.g., networked) to other machines. In a networked deployment, the machine 400 may operate in the capacity of a server machine, a client machine, or both in server-client network environments. In an example, the machine 400 may act as a peer machine in peer-to-peer (P2P) (or other distributed) network environment. The machine 400 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate by, logic or a number of components, or mechanisms. Circuitry is a collection of circuits implemented in tangible entities that include hardware (e.g., simple circuits, gates, logic, etc.). Circuitry membership may be flexible over time and underlying hardware variability. Circuitries include members that may, alone or in combination, perform specified operations when operating. In an example, hardware of the circuitry may be immutably designed to carry out a specific operation (e.g., hardwired). In an example, the hardware of the circuitry may include variably connected physical components (e.g., execution units, transistors, simple circuits, etc.) including a computer readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, the computer readable medium is communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry at a different time.

Machine (e.g., computer system) 400 may include a hardware processor 402 (e.g., a central processing unit (CPU), a graphics processing unit (GPU), a hardware processor core, or any combination thereof), a main memory 404 and a static memory 406, some or all of which may communicate with each other via an interlink (e.g., bus) 408. The machine 400 may further include a display unit 410, an alphanumeric input device 412 (e.g., a keyboard), and a user interface (UI) navigation device 414 (e.g., a mouse). In an example, the display unit 410, input device 412 and. UI navigation device 414 may be a touch screen display. The machine 400 may additionally include a storage device (e.g., drive unit) 416, a signal generation device 418 (e.g., a speaker), a network interface device 420, and one or more sensors 421, such as a global positioning system (GPS) sensor, compass, accelerometer, or other sensor. The machine 400 may include an output controller 428, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.)

The storage device 416 may include a machine readable medium 422 on which is stored one or more sets of data structures or instructions 424 (e.g., software) embodying or utilized by any one or more of the techniques or functions described herein. The instructions 424 may also reside, completely or at least partially, within the main memory 404, within static memory 406, or within the hardware processor 402 during execution thereof by the machine 400. In an example, one or any combination of the hardware processor 402, the main memory 404, the static memory 406, or the storage device 416 may constitute machine readable media.

While the machine readable medium 422 is illustrated as a single medium, the term “machine readable medium” may include a single medium or multiple media (e.g., a centralized or distributed database, and/or associated caches and servers) configured to store the one or more instructions 424.

The term “machine readable medium” may include any medium that is capable of storing, encoding, or carrying instructions for execution by the machine 400 and that cause the machine 400 to perform any one or more of the techniques of the present disclosure, or that is capable of storing, encoding or carrying data structures used by or associated with such instructions. Non-limiting machine readable medium examples may include solid-state memories, and optical and magnetic media. In an example, a massed machine readable medium comprises a machine readable medium with a plurality of particles having invariant (e.g., rest) mass. Accordingly, massed machine-readable media are not transitory propagating signals. Specific examples of massed machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 424 may further be transmitted or received over a communications network 426 using a transmission medium via the network interface device 420 utilizing any one of a number of transfer protocols (e.g., frame relay, internes protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 420 may include one or more physical jacks (e.g., Ethernet, coaxial, or phone jacks) or one or more antennas to connect to the communications network 426. In an example, the network interface device 420 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 400, and includes digital or analog communications signals or other intangible medium to facilitate communication of such software.

### ADDITIONAL NOTES AND N EXAMPLES

Examples can include subject matter such as a method, means for performing acts of the method, at least one machine-readable medium including instructions that, when performed by a machine cause the machine to performs acts of the method, or of an apparatus or system for automatically adjusting hearing aids, according to embodiments and examples described herein.

Example 1 is a device for adjusting a hearing aid, comprising: a processor, when in operation, coupled to a microphone to receive audio signals from an environment, and to an audio output device coupled to the hearing aid to provide improved audio signals to a user, wherein the processor is to generate the improved audio signals from the received audio signals, and wherein the processor includes logic to: identify a classification of the environment based on qualities of the audio signals; determine whether the user is having difficulty hearing; adjust the received audio signals based on the classification of the environment and the determination of whether the user is having difficulty hearing, to generate the improved audio signals; and provide the improved audio signals to the audio output device.

In Example 2, the subject matter of Example 1 optionally includes wherein classification of the environment is based on relevant features extracted from the received audio signals and a determination of into which class the relevant features of the received audio signals are most likely to fit.

In Example 3, the subject matter of Example 2 optionally includes wherein to identify the classification of the environment includes receiving a classification identifier from a local server, and wherein the local server is to extract the relevant features from the received audio signals and perform feature extraction and grouping algorithms on the extracted features for comparison with a classification database to generate the classification identifier.

In Example 4, the subject matter of any one or more of Examples 1-3 optionally include wherein the logic to adjust the received audio signals is to change a mode associated with the device, wherein the mode identifies a configuration of adjustment parameters to be performed responsive to an automatic adjustment triggered by a change of the classification of the environment.

In Example 5, the subject matter of any one or more of Examples 1-4 optionally include wherein the logic to adjust the received audio signals is to change a mode associated with the device, wherein the mode identifies a configuration of adjustment parameters to be performed responsive to an external request to adjust the mode.

In Example 6, the subject matter of Example 5 optionally includes wherein the external request is a user request or a request from a local gateway server.

In Example 7, the subject matter of any one or more of Examples 5-6 optionally include wherein the processor includes logic to provide the mode of the device, the classification of the environment and a qualitative measure of the user hearing to a local gateway server for storage as historical data in a database.

In Example 8, the subject matter of any one or more of Examples 1-7 optionally include wherein logic to determine whether the user is having difficulty hearing is based on user feedback, wherein the feedback includes at least one of a gesture, speech, or tactile interaction with the device.

In Example 9, the subject matter of Example 8 optionally includes wherein the device is to receive an indication of the user feedback for gesture and speech from a local server communicatively coupled to at least one of a microphone or camera, the local server to identify the gesture or speech.

Example 10 is a system for adjusting a hearing aid, comprising: a processor to execute a service for adapting a hearing aid in use by a user in an environment, the service to include: analysis logic to receive audio signals from the environment and to classify the environment based on qualities of the audio signals; feedback logic to assess hearing conditions of the user in the environment based on the audio signals received and perceived quality of the user hearing, the perceived quality of the user hearing to be derived from feedback information received from at least one of the user or a local server in the environment; and adjustment logic to correlate the classification of the environment with the hearing conditions of the user, and to send a mode update to the user's hearing aid, when the mode update is indicated by the correlating.

In Example 11, the subject matter of Example 10 optionally includes wherein the local server is to receive visual and audio signals from the environment and is to identify conditions related to the feedback information associated with the hearing conditions of the user in the environment.

In Example 12, the subject matter of Example 11 optionally includes wherein the service for adapting a hearing aid is to store historical data regarding the hearing conditions of the user in the environment, perceived quality of the user hearing, and a current mode of the hearing aid for use in adapting a second hearing aid in use by a second user.

In Example 13, the subject matter of any one or more of Examples 10-12 optionally include wherein the audio signals are captured by the hearing aid, and wherein the analysis logic is to receive the audio signals from the hearing aid via the local server in the environment.

In Example 14, the subject matter of any one or more of Examples 10-13 optionally include wherein the audio signals are captured by a microphone coupled to a mobile device in the environment, and wherein the analysis logic is to receive the audio signals from the microphone via a wireless transmission to the local server.

In Example 15, the subject matter of any one or more of Examples 10-14 optionally include wherein the audio signals are captured by a microphone mounted in the environment, and wherein the analysis logic is to receive the audio signals from the microphone via a wireless or wired transmission to the local server.

In Example 16, the subject matter of any one or more of Examples 10-15 optionally include wherein the classification of the environment, the assessment of hearing conditions of the user, and a current mode of the hearing aid are to be correlated as historical data and stored in a data store.

In Example 17, the subject matter of Example 16 optionally includes wherein the historical data is to be used by the adjustment logic for a second user to assist in automatic mode adjustment for a second hearing aid in use by the second user.

In Example 18, the subject matter of Example 17 optionally includes wherein the local server is a local gateway server, when in operation, coupled to a network, and comprising logic to forward the historical data via the network to one of a second user, a manufacturer or an audiologist.

In Example 19, the subject matter of any one or more of Examples 10-18 optionally include a camera assembly to capture images in the environment and send the images to the analysis logic, wherein the analysis logic is to analyze the images to identify gestures indicating that the user is having difficulty hearing.

In Example 20, the subject matter of Example 19 optionally includes wherein the camera assembly is one of mounted in the environment, or coupled with a mobile device in the environment.

Example 21 is a computer implemented method for adjusting a hearing aid, comprising: identifying whether a user with the hearing aid is having difficulty hearing to generate a qualitative measure of hearing difficulty, wherein the qualitative measure of hearing difficulty is based on user feedback, and wherein the user feedback includes at least one of a gesture, speech, or tactile interaction with the hearing aid; receiving audio signals associated with an environment in which the user is located; classifying the audio signals associated with the environment to generate an environmental classification, wherein the environmental classification is based on relevant features extracted from the received audio signals and a determination of into which class the relevant features of the received audio signals are most likely to fit; correlating the environmental classification with a current mode of the hearing aid and with the qualitative measure of hearing difficulty to generate correlated historical information; storing the correlated historical information in a data store; and determining whether a mode change is likely to improve the qualitative measure of hearing difficulty based at least on the current mode of the hearing aid, environmental classification of the environment, and correlated historical information, wherein the correlated historical information corresponds to the environmental classification, and when it is determined that a mode change is likely to improve the qualitative measure of hearing difficulty, then sending a mode change instruction to the hearing aid.

In Example 22, the subject matter of Example 21 optionally includes wherein classifying the audio signals associated with the environment to generate the environmental classification includes extracting the relevant features from the audio signals associated with the environment and performing feature extraction and grouping of features on the extracted relevant features, and comparing results of the extracting and grouping with a classification database to generate the environmental classification.

In Example 23, the subject matter of any one or more of Examples 21-22 optionally include identifying at least one of a physical or emotional characteristic of the user; and correlating with the correlated historical information before the storing, wherein the storing includes the correlated historical information further correlated with the at least one of a physical or emotional characteristic of the user.

In Example 24, the subject matter of any one or more of Examples 21-23 optionally include wherein the identifying whether the user with the hearing aid is having difficulty hearing further comprises: receiving images from a camera assembly in the environment; and analyzing the received images to identify gestures indicating that the user is having difficulty hearing.

In Example 25, the subject matter of any one or more of Examples 21-24 optionally include sending the historical information to a manufacturer of the hearing aid for use with other users.

In Example 26, the subject matter of any one or more of Examples 21-25 optionally include receiving historical data associated with a second user for a similar environment; correlating the historical data associated with the second user with the environmental classification, the current mode of the hearing aid, and with the qualitative measure of hearing difficulty to generate an updated mode for the hearing aid of the user; and sending mode change instructions to the hearing aid corresponding to the updated mode.

Example 27 is a system for adjusting hearing aids, comprising means to perform any of the methods recited in Examples 21 to 26.

Example 28 is at least one computer readable storage medium having instructions that when executed on a machine cause the machine to: identify whether a user with a hearing aid is having difficulty hearing to generate a qualitative measure of hearing difficulty, wherein the qualitative measure of hearing difficulty is based on user feedback, and wherein the user feedback includes at least one of a gesture, speech, or tactile interaction with the hearing aid; classify audio signals associated with the environment in which the user is located to generate an environmental classification, wherein the environmental classification is based on relevant features extracted from the received audio signals and a determination of into which class the relevant features of the received audio signals are most likely to fit; correlate the environmental classification with a current mode of the hearing aid and with the qualitative measure of hearing difficulty to generate correlated historical information; store the correlated historical information in a data store; and determine whether a mode change is likely to improve the qualitative measure of hearing difficulty based at least on the current mode of the hearing aid, environmental classification of the environment, and correlated historical information, wherein the correlated historical information corresponds to the environmental classification, and when it is determined that a mode change is likely to improve the qualitative measure of hearing difficulty, then send a mode change instruction to the hearing aid.

In Example 29, the subject matter of Example 28 optionally includes wherein to classify the audio signals associated with the environment to generate the environmental classification includes instructions to extract the relevant features from the audio signals associated with the environment and perform feature extraction and grouping of features on the extracted relevant features, and compare results of the extracting and grouping with a classification database to generate the environmental classification.

In Example 30, the subject matter of any one or more of Examples 28-29 optionally include instructions to: identify at least one of a physical or emotional characteristic of the user; and correlate with the correlated historical information; and store, in the data store, the correlated historical information further correlated with the at least one of a physical or emotional characteristic of the user.

In Example 31, the subject matter of any one or more of Examples 28-30 optionally include wherein the instructions to identify whether the user with the hearing aid is having difficulty hearing includes instructions that when executed on a machine cause the machine to: analyze images of the environment to identify gestures indicating that the user is having difficulty hearing.

In Example 32, the subject matter of any one or more of Examples 28-31 optionally include instructions that when executed on a machine cause the machine to: send the historical information to a manufacturer of the hearing aid for use with other users.

In Example 33, the subject matter of any one or more of Examples 28-32 optionally include instructions that when executed on a machine cause the machine to: receive historical data associated with a second user for a similar environment; correlate the historical data associated with the second user with the environmental classification, the current mode of the hearing aid, and with the qualitative measure of hearing difficulty to generate an updated mode for the hearing aid of the user; and send mode change instructions to the hearing aid corresponding to the updated mode.

Example 34 is at least one computer readable storage medium having instructions that when executed on a machine cause the machine to perform the method of any of Examples 21-26.

Example 35 is a system configured to perform operations of any one or more of Examples 1-33.

Example 36 is a method for performing operations of any one or more of Examples 1-33.

Example 37 is a machine readable medium including instructions that, when executed by a machine cause the machine to perform the operations of any one or more of Examples 1-33.

Example 38 is a system comprising means for performing the operations of any one or more of Examples 1-33.

The techniques described herein are not limited to any particular hardware or software configuration; they may find applicability in any computing, consumer electronics, or processing environment. The techniques may be implemented in hardware, software, firmware or a combination, resulting in logic or circuitry which supports execution or performance of embodiments described herein.

For simulations, program code may represent hardware using a hardware description language or another functional description language which essentially provides a model of how designed hardware is expected to perform. Program code may be assembly or machine language, or data that may be compiled and/or interpreted. Furthermore, it is common in the art to speak of software, in one form or another as taking an action or causing a result. Such expressions are merely a shorthand way of stating execution of program code by a processing system which causes a processor to perform an action or produce a result.

Each program may be implemented in a high level procedural, declarative, and/or object-oriented programming language to communicate with a processing system. However, programs may be implemented in assembly or machine language, if desired. In any case, the language may be compiled or interpreted.

Program instructions may be used to cause a general-purpose or special-purpose processing system that is programmed with the instructions to perform the operations described herein. Alternatively, the operations may be performed by specific hardware components that contain hardwired logic for performing the operations, or by any combination of programmed computer components and custom hardware components. The methods described herein may be provided as a computer program product, also described as a computer or machine accessible or readable medium that may include one or more machine accessible storage media having stored thereon instructions that may be used to program a processing system or other electronic device to perform the methods.

Program code, or instructions, may be stored in, for example, volatile and/or non-volatile memory, such as storage devices and/or an associated machine readable or machine accessible medium including solid-state memory, hard-drives, floppy-disks, optical storage, tapes, flash memory, memory sticks, digital video disks, digital versatile discs (DVDs), etc., as well as more exotic mediums such as machine-accessible biological state preserving storage. A machine readable medium may include any mechanism for storing, transmitting, or receiving information in a form readable by a machine, and the medium may include a tangible medium through which electrical, optical, acoustical or other form of propagated signals or carrier wave encoding the program code may pass, such as antennas, optical fibers, communications interfaces, etc. Program code may be transmitted in the form of packets, serial data, parallel data, propagated signals, etc., and may be used in a compressed or encrypted format.

Program code may be implemented in programs executing on programmable machines such as mobile or stationary computers, personal digital assistants, smart phones, mobile Internet devices, set top boxes, cellular telephones and pagers, consumer electronics devices (including DVD players, personal video recorders, personal video players, satellite receivers, stereo receivers, cable Ty receivers), and other electronic devices, each including a processor, volatile and/or non-volatile memory readable by the processor, at least one input device and/or one or more output devices. Program code may be applied to the data entered using the input device to perform the described embodiments and to generate output information. The output information may be applied to one or more output devices. One of ordinary skill in the art may appreciate that embodiments of the disclosed subject matter can be practiced with various computer system configurations, including multiprocessor or multiple-core processor systems, minicomputers, mainframe computers, as well as pervasive or miniature computers or processors that may be embedded into virtually any device. Embodiments of the disclosed subject matter can also be practiced in distributed computing environments, cloud environments, peer-to-peer or networked microservices, where tasks or portions thereof may be performed by remote processing devices that are linked through a communications network.

A processor subsystem may be used to execute the instruction on the machine-readable or machine accessible media. The processor subsystem may include one or more processors, each with one or more cores. Additionally, the processor subsystem may be disposed on one or more physical devices. The processor subsystem may include one or more specialized processors, such as a graphics processing unit (GPU), a digital signal processor (DSP), a field programmable gate array (FPGA), or a fixed function processor.

Although operations may be described as a sequential process, some of the operations may in fact be performed in parallel, concurrently, and/or in a distributed. environment, and with program code stored locally and/or remotely for access by single or multi-processor machines. In addition, in some embodiments the order of operations may be rearranged without departing from the spirit of the disclosed subject matter. Program code may be used by or in conjunction with embedded controllers.

Examples, as described herein, may include, or may operate on, circuitry, logic or a number of components, modules, or mechanisms. Modules may be hardware, software, or firmware communicatively coupled to one or more processors in order to carry out the operations described herein. It will be understood that the modules or logic may be implemented in a hardware component or device, software or firmware running on one or more processors, or a combination. The modules may be distinct and independent components integrated by sharing or passing data, or the modules may be subcomponents of a single module, or be split among several modules. The components may be processes running on, or implemented on, a single compute node or distributed among a plurality of compute nodes running in parallel, concurrently, sequentially or a combination, as described more fully in conjunction with the flow diagrams in the figures. As such, modules may be hardware modules, and as such modules may be considered tangible entities capable of performing specified operations and may be configured or arranged in a certain manner. In an example, circuits may be arranged (e.g., internally or with respect to external entities such as other circuits) in a specified manner as a module. in an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations. Accordingly, the term hardware module is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured, arranged or adapted by using software; the general-purpose hardware processor may be configured as respective different modules at different times. Software may accordingly configure a hardware processor, for example, to constitute a particular module at one instance of time and to constitute a different module at a different instance of time. Modules may also be software or firmware modules, which operate to perform the methodologies described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

While this subject matter has been described with reference to illustrative embodiments, this description is not intended to be construed in a limiting or restrictive sense. For example, the above-described examples (or one or more aspects thereof) may be used in combination with others. Other embodiments may be used, such as will be understood by one of ordinary skill in the art upon reviewing the disclosure herein. The Abstract is to allow the reader to quickly discover the nature of the technical disclosure. However, the Abstract is submitted with the understanding that it will not be used to interpret or limit the scope or meaning of the claims.

1. A device for adjusting a hearing aid, comprising:
a processor, when in operation, coupled to a microphone to receive audio signals from an environment, and to an audio output device coupled to the hearing aid to provide improved audio signals to a user, wherein the processor is to generate the improved audio signals from the received audio signals, and wherein the processor includes logic to:
identify a classification of the environment based on qualities of the audio signals;
determine whether the user is having difficulty hearing;
adjust the received audio signals based on the classification of the environment and the determination of whether the user is having difficulty hearing, to generate the improved audio signals; and
provide the improved audio signals to the audio output device.

2. The device as recited in claim 1, wherein classification of the environment is based on relevant features extracted from the received audio signals and a determination of into which class the relevant features of the received audio signals are most likely to fit, to include logic to receive a classification identifier from a local server, and wherein the local server is to extract the relevant features from the received audio signals and perform feature extraction and grouping algorithms on the extracted features for comparison with a classification database to generate the classification identifier.

3. The device as recited in claim 1, wherein the logic to adjust the received audio signals is to change a mode associated with the device, wherein the mode identifies a configuration of adjustment parameters to be performed responsive to an automatic adjustment triggered by a change of the classification of the environment.

4. The device as recited in claim 1, wherein the logic to adjust the received audio signals is to change a mode associated with the device, wherein the mode identifies a configuration of adjustment parameters to be performed responsive to an external request to adjust the mode, wherein the external request is a user request or a request from a local gateway server.

5. The device as recited in claim 4, wherein the processor includes logic to provide the mode of the device, the classification of the environment and a qualitative measure of the user hearing to a local gateway server for storage as historical data in a database.

6. The device as recited in claim 1, wherein logic to determine whether the user is having difficulty hearing is based on user feedback, wherein the feedback includes at least one of a gesture, speech, or tactile interaction with the device, wherein the device is to receive an indication of the user feedback for gesture and speech from a local server communicatively coupled to at least one of a microphone or camera, the local server to identify the gesture or speech.

7. A system for adjusting a hearing aid, comprising:
a processor to execute a service for adjusting a hearing aid in use by a user in an environment, the service to include:
analysis logic to receive audio signals from the environment and to classify the environment based on qualities of the audio signals;
feedback logic to assess hearing conditions of the user in the environment based on the audio signals received and perceived quality of the user hearing, the perceived quality of the user hearing to be derived from feedback information received from at least one of the user or a local server in the environment; and
adjustment logic to correlate the classification of the environment with the hearing conditions of the user, and to send a mode update to the user's hearing aid, when the mode update is indicated by the correlating.

8. The system as recited in claim 7, wherein the local server is to receive visual and audio signals from the environment and is to identify conditions related to the feedback information associated with the hearing conditions of the user in the environment.

9. The system as recited in claim 8, wherein the service for adapting a hearing aid is to store historical data regarding the hearing conditions of the user in the environment, perceived quality of the user hearing, and a current mode of the hearing aid for use in adapting a second hearing aid in use by a second user.

10. The system as recited in claim 7, wherein the audio signals are captured by hearing aid, and wherein the analysis logic is to receive the audio signals from the hearing aid via the local server in the environment.

11. The system as recited in claim 7, wherein the audio signals are captured by a microphone in the environment, the microphone coupled to a mobile device or mounted in the environment, and wherein the analysis logic is to receive the audio signals from the microphone via a wireless or wired transmission to the local server.

12. The system as recited in claim 7, wherein the classification of the environment, the assessment of hearing conditions of the user, and a current mode of the hearing aid are to be correlated as historical data and stored in a data store.

13. The system as recited in claim 12, wherein the historical data is to be used by the adjustment logic for a second user to assist in automatic mode adjustment for a second hearing aid in use by the second user.

14. The system as recited in claim 13, wherein the local server is a local gateway server, when in operation, coupled to a network, and comprising logic to forward the historical data via the network to one of a second user, a manufacturer or an audiologist.

15. The system as recited in claim 7, further comprising a camera assembly to capture images in the environment and send the images to the analysis logic, wherein the analysis logic is to analyze the images to identify gestures indicating that the user is having difficulty hearing, wherein the camera assembly is one of mounted in the environment, or coupled with a mobile device in the environment.

16. A computer implemented method for adjusting a hearing aid, comprising:
identifying whether a user with the hearing aid is having difficulty hearing to generate a qualitative measure of hearing difficulty, wherein the qualitative measure of hearing difficulty is based on user feedback, and wherein the user feedback includes at least one of a gesture, speech, or tactile interaction with the hearing aid;
receiving audio signals associated with an environment in which the user is located;
classifying the audio signals associated with the environment to generate an environmental classification, wherein the environmental classification is based on relevant features extracted from the received audio signals and a determination of into which class the relevant features of the received audio signals are most likely to fit;
correlating the environmental classification with a current mode of the hearing aid and with the qualitative measure of hearing difficulty to generate correlated historical information;
storing the correlated historical information in a data store; and
determining whether a mode change is likely to improve the qualitative measure of hearing difficulty based at least on the current mode of the hearing aid, environmental classification of the environment, and correlated historical information, wherein the correlated historical information corresponds to the environmental classification, and when it is determined that a mode change is likely to improve the qualitative measure of hearing difficulty, then sending a mode change instruction to the hearing aid.

17. The method as recited in claim 16, wherein classifying the audio signals associated with the environment to generate the environmental classification includes extracting the relevant features from the audio signals associated with the environment and performing feature extraction and grouping of features on the extracted relevant features, and comparing results of the extracting and grouping with a classification database to generate the environmental classification.

18. The method as recited in claim 16, further comprising:
identifying at least one of a physical or emotional characteristic of the user; and
correlating with the correlated historical information before the storing, wherein the storing includes the correlated historical information further correlated with the at least one of a physical or emotional characteristic of the user.

19. The method as recited in claim 16, wherein the identifying whether the user with the hearing aid is having difficulty hearing further comprises:
receiving images from a camera assembly in the environment; and
analyzing the received images to identify gestures indicating that the user is having difficulty hearing.

20. The method as recited in claim 16, further comprising:
sending the historical information to a manufacturer of the hearing aid for use with other users;
receiving historical data associated with a second user for a similar environment;
correlating the historical data associated with the second user with the environmental classification, the current mode of the hearing aid, and with the qualitative measure of hearing difficulty to generate an updated mode for the hearing aid of the user; and
sending mode change instructions to the hearing aid corresponding to the updated mode.

21. At least one computer readable storage medium having instructions that when executed on a machine cause the machine to:
identify whether a user with a hearing aid is having difficulty hearing to generate a qualitative measure of hearing difficulty, wherein the qualitative measure of hearing difficulty is based on user feedback, and wherein the user feedback includes at least one of a gesture, speech, or tactile interaction with the hearing aid;
classify audio signals associated with the environment in which the user is located to generate an environmental classification, wherein the environmental classification is based on relevant features extracted from the received audio signals and a determination of into which class the relevant features of the received audio signals are most likely to fit;
correlate the environmental classification with a current mode of the hearing aid and with the qualitative measure of hearing difficulty to generate correlated historical information;
store the correlated historical information in a data store; and
determine whether a mode change is likely to improve the qualitative measure of hearing difficulty based at least on the current mode of the hearing aid, environmental classification of the environment, and correlated historical information, wherein the correlated historical information corresponds to the environmental classification, and when it is determined that a mode change is likely to improve the qualitative measure of hearing difficulty, then send a mode change instruction to the hearing aid.

22. The at least one medium as recited in claim 21, wherein to classify the audio signals associated with the environment to generate the environmental classification includes instructions to extract the relevant features from the audio signals associated with the environment and perform feature extraction and grouping of features on the extracted relevant features, and compare results of the extracting and grouping with a classification database to generate the environmental classification.

23. The at least one medium as recited in claim 21, further comprising instructions to:
identify at least one of a physical or emotional characteristic of the user; and
correlate with the correlated historical information; and
store, in the data store, the correlated historical information further correlated with the at least one of a physical or emotional characteristic of the user.

24. The at least one medium as recited in claim 21, wherein the instructions to identify whether the user with the hearing aid is having difficulty hearing includes instructions that when executed on a machine cause the machine to analyze images of the environment to identify gestures indicating that the user is having difficulty hearing.

25. The at least one medium as recited in claim 21, further comprising instructions that when executed on a machine cause the machine to:
send the historical information to a manufacturer of the hearing aid for use with other users;
receive historical data associated with a second user for a similar environment;
correlate the historical data associated with the second user with the environmental classification, the current mode of the hearing aid, and with the qualitative measure of hearing difficulty to generate an updated mode for the hearing aid of the user; and
send mode change instructions to the hearing aid corresponding to the updated mode.
